(19) United States
(12) Patent Application Publication
(10) Pub. No.: US 2019/0061547 A1
(43) Pub. Date: Feb. 28, 2019

(54) SYSTEMS AND METHODS FOR LOAD SHARING IN ELECTRIC VEHICLE CHARGING INSTALLATIONS

(71) Applicant: Electric Motor Werks, Inc., San Carlos, CA (US)

(72) Inventors: DORIAN VARGAS-REIGHLEY, La Selva Beach, CA (US); VALERY MIFTAKHOV, San Carlos, CA (US)

(73) Assignee: Electric Motor Werks, Inc., San Carlos, CA (US)

(21) Appl. No.: 15/693,306

(22) Filed: Aug. 31, 2017

(51) Int. Cl. B60L 11/18; H04L 29/08

(52) U.S. Cl. CPC B60L 11/1844; B60L 11/1816; H04W 84/12; B60L 2230/16; H04L 67/125

(57) ABSTRACT

System for dynamic load sharing within a distributed installation of EVSEs fed off a single supply circuit, using wireless local area network consisting of one central control unit wirelessly connecting to each EVSE within the installation. EVSEs connect to the central control unit using a wireless network. A load group can be configured of any number of EVSEs set to share a single electric supply circuit of any predetermined amperage. EVSEs will then dynamically balance their collective load out according to what the demands on each respective station are. EVSEs are in constant communication with the corresponding EVs plugged in for charging, and the central hub is in constant communication with each EVSEs. Communication exists for purposes of dynamic load setting and the available electrical power is constantly re-allocated among the charging group, depending on the load draws of each EVSE/EV relationship.

### BACKGROUND OF THE INVENTION

### Field of the Invention

The disclosed embodiments relate in general to electric vehicle charging technology, and, more specifically, to systems and methods for load sharing in electric vehicle charging installations.

### Description of the Related Art

When attempting to supply multiple electric vehicle charging stations, also called electric vehicle supply equipment or EVSE, there is often a problem of overloading the electrical supply circuit. Various load control techniques, such as establishing a load control group, are used to prevent this situation. A load control group is a networked and defined set of current delivering devices, in this case EVSEs, which are capable of communication in order to share a single electrical supply circuit without overdrawing that circuit, with the goal of optimizing distributed electric vehicle charging activities.

Conventional electrical supply circuit sharing is carried out in one of two ways. In first implementation, a cloud software system in which load allotment algorithms and assignments are communicated from EVs to EVSEs to servers and vice versa via the Internet at large. The other conventional implementation uses a hardwired load control system in which the hub resides within the circuit panel, and is connected via RJ45 (or similar) to each load device (EVSE)—this method utilizes static load control (per EVSE load limits are set to divisors of total capacity, and do not deviate based upon demand).

Unfortunately, the above-described conventional electrical supply circuit sharing techniques do not work in the absence of the Internet connection, when dynamic load sharing is desired. Therefore, new and improved systems and methods for electrical supply circuit sharing in connection with EVSE are needed.

### SUMMARY OF THE INVENTION

The inventive methodology is directed to methods and systems that substantially obviate one or more of the above and other problems associated with conventional EV charging technology.

In accordance with one aspect of the embodiments described herein, there is provided a system for electric vehicle charging comprising: a plurality of electric vehicle supply equipment stations for charging a plurality of electric vehicle batteries from an electric supply circuit; and a central control hub communicatively coupled with each of the plurality of the electric vehicle supply equipment stations via a wireless data network and executing a software application for dynamically allocating available electrical power supplied by the electric supply circuit to the plurality of electric vehicle supply equipment stations to enable charging the plurality of electric vehicle batteries.

In one or more embodiments, each of the plurality of electric vehicle supply equipment stations is operable to send a current demand communication to the central control hub requesting an allocation of a portion of the available electrical power supplied by the electric supply circuit.

In one or more embodiments, the current demand communication sent by each of the plurality of electric vehicle supply equipment stations is based on a load demand received from a corresponding electric vehicle to be charged.

In one or more embodiments, the central control hub is operable to send a load limit setting communication to at least one of the plurality of electric vehicle supply equipment stations to set a load limit for the respective electric vehicle supply equipment station based on the dynamically allocated available electrical power.

In one or more embodiments, in response to the receipt of the load limit setting communication from the central control hub, the receiving least one of the plurality of electric vehicle supply equipment stations is operable to start charging the corresponding electric vehicle based on the set load limit.

In one or more embodiments, the software application dynamically allocates available electrical power without relying on an Internet connection.

In one or more embodiments, one or more of the plurality of electric vehicle supply equipment stations are assigned to a load group and wherein the load group shares the available electrical power supplied by the electric supply circuit.

In accordance with another aspect of the embodiments described herein, there is provided a method for electric vehicle charging comprising: coupling a plurality of electric vehicle supply equipment stations with a plurality of electric vehicles each comprising a battery, the plurality of electric vehicle supply equipment stations being electrically supplied from an electric supply circuit; and communicatively coupling via a wireless data network a central control hub with each of the plurality of the electric vehicle supply equipment stations; and dynamically allocating available electrical power supplied by the electric supply circuit to the plurality of electric vehicle supply equipment stations to enable charging the plurality of electric vehicle batteries.

In one or more embodiments, each of the plurality of electric vehicle supply equipment stations is operable to send a current demand communication to the central control hub requesting an allocation of a portion of the available electrical power supplied by the electric supply circuit.

In one or more embodiments, the current demand communication sent by each of the plurality of electric vehicle supply equipment stations is based on a load demand received from a corresponding electric vehicle to be charged.

In one or more embodiments, the central control hub is operable to send a load limit setting communication to at least one of the plurality of electric vehicle supply equipment stations to set a load limit for the respective electric vehicle supply equipment station based on the dynamically allocated available electrical power.

In one or more embodiments, in response to the receipt of the load limit setting communication from the central control hub, the receiving least one of the plurality of electric vehicle supply equipment stations is operable to start charging the corresponding electric vehicle based on the set load limit.

In one or more embodiments, the software application dynamically allocates available electrical power without relying on an Internet connection.

In one or more embodiments, one or more of the plurality of electric vehicle supply equipment stations are assigned to a load group and wherein the load group shares the available electrical power supplied by the electric supply circuit.

In accordance with yet another aspect of the embodiments described herein, there is provided a non-transitory computer-readable medium embodying a set of computer-readable instructions implementing a method for electric vehicle charging comprising: coupling a plurality of electric vehicle supply equipment stations with a plurality of electric vehicles each comprising a battery, the plurality of electric vehicle supply equipment stations being electrically supplied from an electric supply circuit; and communicatively coupling via a wireless data network a central control hub with each of the plurality of the electric vehicle supply equipment stations; and dynamically allocating available electrical power supplied by the electric supply circuit to the plurality of electric vehicle supply equipment stations to enable charging the plurality of electric vehicle batteries.

In one or more embodiments, each of the plurality of electric vehicle supply equipment stations is operable to send a current demand communication to the central control hub requesting an allocation of a portion of the available electrical power supplied by the electric supply circuit.

In one or more embodiments, the current demand communication sent by each of the plurality of electric vehicle supply equipment stations is based on a load demand received from a corresponding electric vehicle to be charged.

In one or more embodiments, the central control hub is operable to send a load limit setting communication to at least one of the plurality of electric vehicle supply equipment stations to set a load limit for the respective electric vehicle supply equipment station based on the dynamically allocated available electrical power.

In one or more embodiments, in response to the receipt of the load limit setting communication from the central control hub, the receiving least one of the plurality of electric vehicle supply equipment stations is operable to start charging the corresponding electric vehicle based on the set load limit.

In one or more embodiments, the software application dynamically allocates available electrical power without relying on an Internet connection.

In one or more embodiments, one or more of the plurality of electric vehicle supply equipment stations are assigned to a load group and wherein the load group shares the available electrical power supplied by the electric supply circuit.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive dynamic load sharing system for EVSE installations.

FIG. 2 illustrates an exemplary operating sequence of an embodiment of the inventive dynamic load sharing system for EVSE installations.

FIG. 3 is a block diagram that illustrates an embodiment of a computer/server system upon which an embodiment of the inventive technology may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

In accordance with one aspect of the embodiments described herein, there are provided novel systems and methods for dynamic electric supply circuit sharing by multiple EVSEs within an installation. In one or more embodiments, the novel dynamic load system establishes a wireless local area network, thus obfuscating the need for RJ45 wired connections, as well as the need to have the load sharing hub running from the electric supply circuit panel. The described system brings the charge optimizing efficiency of dynamic load sharing.

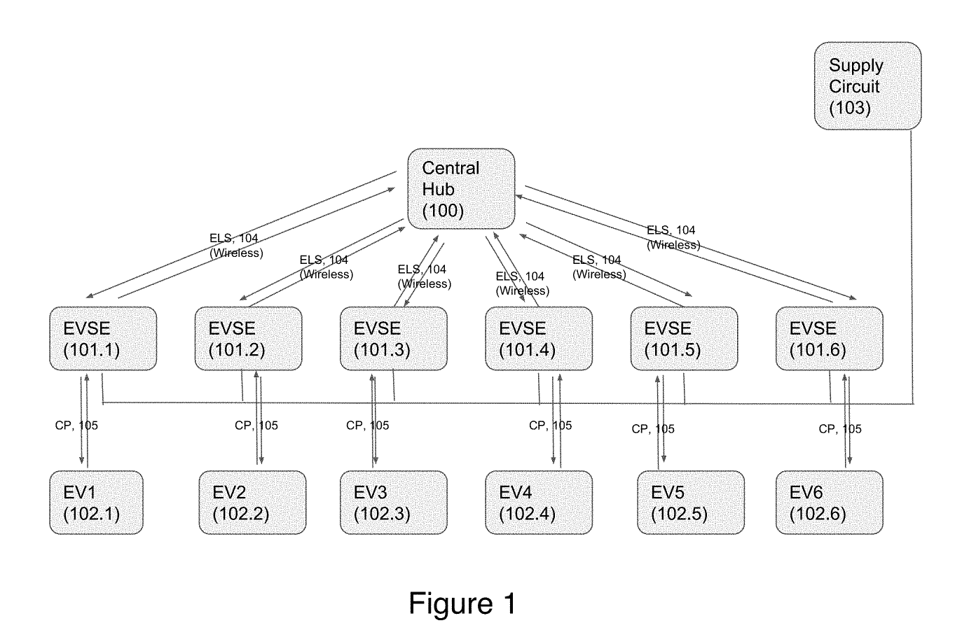

FIG. 1 illustrates an exemplary embodiment of the inventive dynamic load sharing system for EVSE installations. The embodiment of the system shown in FIG. 1 incorporates a central hub or central master control unit 100, which operates to balance the electrical loads drawn by multiple EVSEs 101.1-101.6. In one or more embodiments, the central hub 100 has a wireless connection capability to connect to EVSEs 101.101-101.6 using, for example, WIFI technology well-known to persons of ordinary skill in the art. In one or more embodiments, the central hub 100 executes software for controlling the EVSEs 101.101-101.6.

Each of the EVSEs 101.1-101.6 is a smart vehicle charging station with wireless networking and wireless telemetry capability. Each of the EVSEs 101.1-101.6 is connected to a corresponding electric vehicle (EV) 102.1-102.6. In various embodiments, the EVs 102.1-102.6 may be any vehicles with a battery system and electric propulsion system capable of receiving electric charge. In addition, the system shown in FIG. 1 incorporates an electrical supply circuit 103, which is an electrical circuit supplying power for EVSEs.

In one or more embodiments, the central hub 100 and the EVSEs 101.1-101.6 communicate via a wireless network to exchange electrical load status (ELS) communications 104. The exchanged electrical load status communications 104 may include, without limitation, current load demand communications from the EVSEs 101.1-101.6 to the central hub 100 requesting a certain current to be allocated to specific EVSEs 101.1-101.6. In addition, the exchanged load status communications 104 may further include load limit setting communications from the central hub 100 to the respective EVSEs 101.1-101.6 setting specific electrical load limit.

The EVSEs 101.1-101.6 are connected to the corresponding EVs 102.1-102.6 by means of control pilot (CP) 105, which supplies charging power from the EVSEs 101.1-101.6 to EVs 102.1-102.6. The control pilot 105 is used for communicating electrical load demand from EVs to respective EVSEs using power line communication (PLC), well known to persons of ordinary skill in the art, as well as for high power transfer from the EVSEs 101.1-101.6 to EVs 102.1-102.6.

The system shown in FIG. 1 enables dynamic load sharing within a distributed installation of EVSEs 101.101-101.6 fed off a single supply circuit 103, using the wireless local area network consisting of one central control unit 100 wirelessly connecting to each EVSE 101.101-101.6 within the installation. The shown system does not require an external Internet connection nor does it require connection to a cloud network. In one or more embodiments, EVSEs 101.101-101.6 do not connect to one another, only to the central control unit 100. In one or more embodiments, a load group can be configured of any number of EVSEs 101.101-101.6, set to share a single electric supply circuit of any predetermined amperage. Aforementioned EVSEs 101.101-101.6 will then dynamically balance their collective load out according to what the demands on each respective station are. EVSEs 101.101-101.6 are in constant communication with the corresponding EVs 102.1-102.6 plugged in for charging, and the central hub 100 is in constant communication with each EVSEs 101.101-101.6. Communication exists for purposes of dynamic load setting and the available electrical power is constantly re-allocated among the load group, depending on the load draws of each EVSE/EV relationship.

In one example, a user has a single electric supply circuit with 90 A capacity, and a load group of 3 30 A EVSEs is desired. In the event that the user has 3 EVs all charging on those EVSEs at once, the user will end up with 30 A devoted to each EVSE. Over time, one EV will begin ramping down it's current consumption as it reaches full charge. When this takes place, the load demand of that EVSE/EV relationship decreases and the available electrical power is automatically re-distributed to the remaining two EVSE/EVs, until the full 90 A capacity is available to be split among the two remaining EVSEs and leaving 10 A to spare.

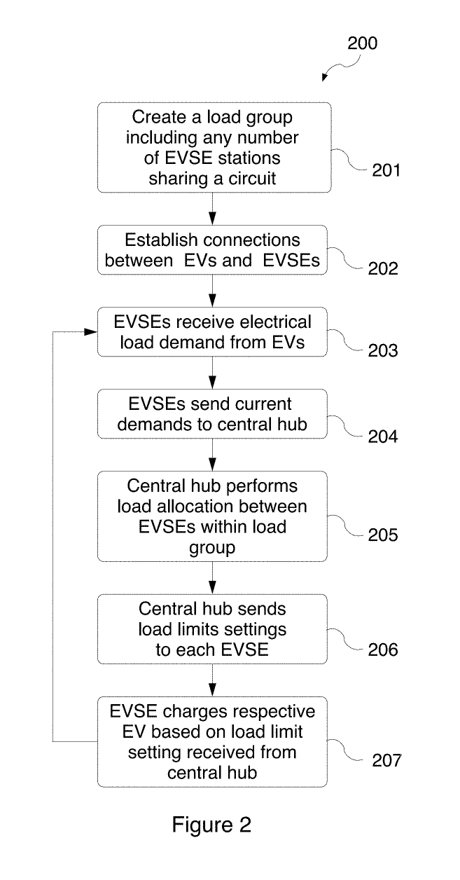

FIG. 2 illustrates an exemplary operating sequence 200 of an embodiment of the inventive dynamic load sharing system for EVSE installations. At step 201, a load group is established, which may include any number of EVSEs 101.1-101.6 to share a supply circuit 103. At step 202, electrical connections between the EVSEs 101.1-101.6 and the respective EVs 102.1-102.6 are established. At step 203, the EVSEs 101.1-101.6 within the load group receive electrical load demands from the respective EVs 102.1-102.6 via the control pilot (CP) 105.

At step 204, the EVSEs 101.1-101.6 send current demand communications to the central hub 100 via the wireless network. The current demand communications are based on the electrical load demands from the respective EVs 102.1-102.6. At step 205, the central hub 100 performs load balancing between EVSEs 101.1-101.6 within the load group based on the available capacity of the supply circuit 130. At step 206, the central hub 100 sends load limit settings to each of the EVSEs 101.1-101.6 within the load group. Finally, at step 207, each of the EVSEs 101.1-101.6 charges the respective EV based on the load limit setting received from the central hub 100. The steps 203-207 of the above process are then repeated.

In one or more embodiments, the described dynamic load sharing system is configured to provide load balancing in an installation incorporating photovoltaic electrical energy production as well EVSEs. In one or more embodiments, the photovoltaic electrical energy for powering the aforesaid installation may be produced using a predetermined number of photovoltaic panels well known to persons of ordinary skill in the art and widely available commercially, coupled to a suitable photovoltaic inverter, such as Sunny Boy inverter commercially available from SMA America. The components of the installation, including the EVSEs, the photovoltaic inverter and the central hub 100 are interconnected via a local wireless data network without the need for an outside networking connection to the Internet. Exemplary systems and methods for integration of electric vehicle charging stations with photovoltaic, wind, hydro, thermal and other alternative energy generation equipment are described in U.S. patent application Ser. No. 15/690,272, incorporated by reference herein.

In one or more embodiments, the photovoltaic power generated by the photovoltaic panels and converted using the photovoltaic inverter is directly matched by the central hub 100 with the electric power energy requirements of the EVSEs and EVs that are being charged on-site, with the goal of optimizing EV charging to consume as much locally generated photovoltaic power as possible. As would be appreciated by persons of ordinary skill in the art, this matching of the produced photovoltaic power with the power consumed by the EVSEs and EVs can be considered as a traditional load sharing model, except the source circuit that is being shared by the EVSE network is the on-site photovoltaic system.

In one illustrative example, a facility with an installed 50 kW photovoltaic array additionally deploys 10 Smart EVSEs for EV charging. As would be appreciated by persons of ordinary skill in the art, the photovoltaic power generation by such a facility would not always be 50 kW, but will heavily depend on many factors, such as time of day, weather conditions, cleanliness of the photovoltaic panel surface, etc.

Suppose it is 2 PM, on a sunny day and the panels are clean. Photovoltaic energy production under these conditions would be near its peak, say at 42 kW. The central hub 100 is linked with the aforesaid photovoltaic array via a smart meter. Let's further assume that four EVs with the charging power consumption of 10 kW each are plugged in to charge into the respective EVSEs, with all EVs having a state of charge (SOC) at 0-95%. Based on the above assumptions, the total power draw of all four EVs would be 40 kW. Suppose, a fifth EV with 10 kW charging power draw plugs in, and the total power draw becomes 50 kW. The central hub 100 now detects that the total power draw by all EVSEs is in excess of the photovoltaic power production, and distributes the available photovoltaic power among all five connected EVs. All the above load sharing rules apply.

Suppose that later that evening fog rolls in. The photovoltaic production is now at 30 kW, and continues to fall. Suppose the aforesaid five EVs are still connected to the installation and still have 10 kW total power demand. However, the new collective limit on the available electrical power is only 30 kW. 30 minutes later, it becomes even darker and cloudier and collective limit is now 15 kW, which the central hub 100 distributes among all the connected EVs.

It should be further noted that the load balancing techniques described about are not limited to powering EVSE. The same techniques, with minor modifications, may be applied to balancing other electrical loads within a household. Exemplary electrical loads that could be balanced using the described inventive techniques include all household or business electrical appliances. In one embodiment, the aforesaid appliances may be separately metered using separate appliance power stations, which operate similarly to EVSE and be connected to the central hub 100 using a wireless network, such as WIFI. Specifically, the appliance power stations would are configured to send power demands to the central hub 100 on behalf of the respective appliances connected thereto and power the aforesaid appliances in accordance with the set power limit command sent by the central hub 100.

In another embodiment, the appliances themselves are WIFI-capable and are configured to send the power demands to the central hub 100 and execute the received set power limit commands. The central hub 100 would distribute the available power among the requesting appliances just as described above in an installation of EVSEs.

### Exemplary Computer Platform

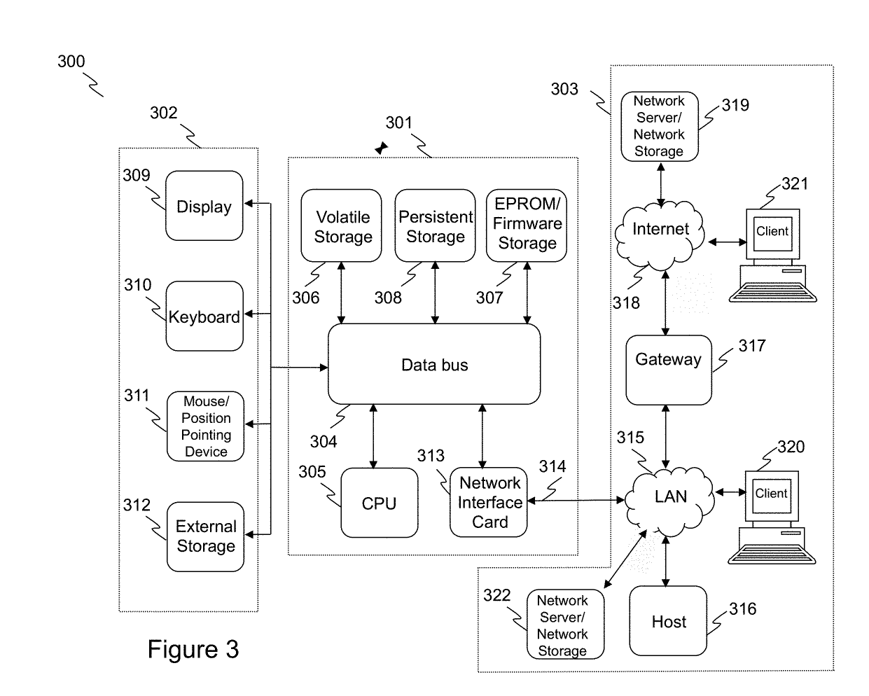

FIG. 3 is a block diagram that illustrates an embodiment of a computer/server system 300 upon which an embodiment of the inventive methodology may be implemented. The system 300 includes a computer/server platform 301, peripheral devices 302 and network resources 303. As would be appreciated by persons of ordinary skill in the art, various embodiments described hereinabove may be deployed based on the aforesaid computer/server system 300, which, in one embodiment, could be used as a building block for the cloud control server 105.

The computer platform 301 may include a data bus 305 or other communication mechanism for communicating information across and among various parts of the computer platform 301, and a processor 305 coupled with bus 301 for processing information and performing other computational and control tasks. Computer platform 301 also includes a volatile storage 306, such as a random access memory (RAM) or other dynamic storage device, coupled to bus 305 for storing various information as well as instructions to be executed by processor 305. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 301 for storing information and instructions.

Computer platform 301 may be coupled via bus 305 to a display 309, such as a cathode ray tube (CRT), plasma display, or a liquid crystal display (LCD), for displaying information to a system administrator or user of the computer platform 301. An input device 310, including alphanumeric and other keys, is coupled to bus 301 for communicating information and command selections to processor 305. Another type of user input device is cursor control device 311, such as a mouse, a trackball, or cursor direction keys for communicating direction information and command selections to processor 305 and for controlling cursor movement on display 309. This input device typically has two degrees of freedom in two axes, a first axis (e.g., x) and a second axis (e.g., y), that allows the device to specify positions in a plane.

An external storage device 312 may be coupled to the computer platform 301 via bus 305 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 305. The bus 305 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 305. Communication interface 313 provides a two-way data communication coupling to a network link 315 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 313 sends and receives electrical, electromagnetic or optical signals that carry digital data streams representing various types of information.

Network link 315 typically provides data communication through one or more networks to other network resources. For example, network link 315 may provide a connection through local network 315 to a host computer 316, or a network storage/server 317. Additionally or alternatively, the network link 313 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 315 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client(s) 320 and/or 321 through Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in systems and methods for load sharing in electric vehicle charging installations. It is intended that the specification and examples be considered as exemplary only, with a true scope and spirit of the invention being indicated by the following claims.

What is claimed is:

1. A system for electric vehicle charging comprising:
a. a plurality of electric vehicle supply equipment stations for charging a plurality of electric vehicle batteries from an electric supply circuit; and
b. a central control hub communicatively coupled with each of the plurality of the electric vehicle supply equipment stations via a wireless data network and executing a software application for dynamically allocating available electrical power supplied by the electric supply circuit to the plurality of electric vehicle supply equipment stations to enable charging the plurality of electric vehicle batteries.

2. The system for electric vehicle charging of claim 1, wherein each of the plurality of electric vehicle supply equipment stations is operable to send a current demand communication to the central control hub requesting an allocation of a portion of the available electrical power supplied by the electric supply circuit.

3. The system for electric vehicle charging of claim 2, wherein the current demand communication sent by each of the plurality of electric vehicle supply equipment stations is based on a load demand received from a corresponding electric vehicle to be charged.

4. The system for electric vehicle charging of claim 1, wherein the central control hub is operable to send a load limit setting communication to at least one of the plurality of electric vehicle supply equipment stations to set a load limit for the respective electric vehicle supply equipment station based on the dynamically allocated available electrical power.

5. The system for electric vehicle charging of claim 4, wherein in response to the receipt of the load limit setting communication from the central control hub, the receiving least one of the plurality of electric vehicle supply equipment stations is operable to start charging the corresponding electric vehicle based on the set load limit.

6. The system for electric vehicle charging of claim 1, wherein the software application dynamically allocates available electrical power without relying on an Internet connection.

7. The system for electric vehicle charging of claim 1, wherein one or more of the plurality of electric vehicle supply equipment stations are assigned to a load group and wherein the load group shares the available electrical power supplied by the electric supply circuit.

8. A method for electric vehicle charging comprising:
a. coupling a plurality of electric vehicle supply equipment stations with a plurality of electric vehicles each comprising a battery, the plurality of electric vehicle supply equipment stations being electrically supplied from an electric supply circuit; and
b. communicatively coupling via a wireless data network a central control hub with each of the plurality of the electric vehicle supply equipment stations; and
c. dynamically allocating available electrical power supplied by the electric supply circuit to the plurality of electric vehicle supply equipment stations to enable charging the plurality of electric vehicle batteries.

9. The method for electric vehicle charging of claim 8, wherein each of the plurality of electric vehicle supply equipment stations is sends a current demand communication to the central control hub requesting an allocation of a portion of the available electrical power supplied by the electric supply circuit.

10. The method for electric vehicle charging of claim 9, wherein the current demand communication sent by each of the plurality of electric vehicle supply equipment stations is based on a load demand received from a corresponding electric vehicle to be charged.

11. The method for electric vehicle charging of claim 8, wherein the central control hub is operable to send a load limit setting communication to at least one of the plurality of electric vehicle supply equipment stations to set a load limit for the respective electric vehicle supply equipment station based on the dynamically allocated available electrical power.

12. The method for electric vehicle charging of claim 11, wherein in response to the receipt of the load limit setting communication from the central control hub, the receiving least one of the plurality of electric vehicle supply equipment stations is operable to start charging the corresponding electric vehicle based on the set load limit.

13. The method for electric vehicle charging of claim 8, wherein the software application dynamically allocates available electrical power without relying on an Internet connection.

14. The method for electric vehicle charging of claim 1, wherein one or more of the plurality of electric vehicle supply equipment stations are assigned to a load group and wherein the load group shares the available electrical power supplied by the electric supply circuit.

15. A non-transitory computer-readable medium embodying a set of computer-readable instructions implementing a method for electric vehicle charging comprising:
a. coupling a plurality of electric vehicle supply equipment stations with a plurality of electric vehicles each comprising a battery, the plurality of electric vehicle supply equipment stations being electrically supplied from an electric supply circuit; and
b. communicatively coupling via a wireless data network a central control hub with each of the plurality of the electric vehicle supply equipment stations; and
c. dynamically allocating available electrical power supplied by the electric supply circuit to the plurality of electric vehicle supply equipment stations to enable charging the plurality of electric vehicle batteries.

16. The non-transitory computer-readable medium of claim 15, wherein each of the plurality of electric vehicle supply equipment stations is sends a current demand communication to the central control hub requesting an allocation of a portion of the available electrical power supplied by the electric supply circuit.

17. The non-transitory computer-readable medium of claim 16, wherein the current demand communication sent by each of the plurality of electric vehicle supply equipment stations is based on a load demand received from a corresponding electric vehicle to be charged.

18. The non-transitory computer-readable medium of claim 15, wherein the central control hub is operable to send a load limit setting communication to at least one of the plurality of electric vehicle supply equipment stations to set a load limit for the respective electric vehicle supply equipment station based on the dynamically allocated available electrical power.

19. The non-transitory computer-readable medium of claim 18, wherein in response to the receipt of the load limit setting communication from the central control hub, the receiving least one of the plurality of electric vehicle supply equipment stations is operable to start charging the corresponding electric vehicle based on the set load limit.

20. The non-transitory computer-readable medium of claim 15, wherein the software application dynamically allocates available electrical power without relying on an Internet connection.
